(19) United States
(12) Patent Application Publication
(10) Pub. No.: US 2026/0328022 A1
(43) Pub. Date: Oct. 22, 2026

(54) ARTICLE SECURITY DEVICE

(71) Applicant: Sensormatic Electronics, LLC, Boca Raton, FL (US)

(72) Inventor: Channing Everet MILLER, Easley, SC (US)

(21) Appl. No.: 19/559,148

(22) Filed: Mar. 6, 2026

Related U.S. Application Data
(60) Provisional application No. 63/770,210, filed on Mar. 11, 2025.

(51) Int. Cl. E05B 73/00

(52) U.S. Cl. CPC E05B 73/0029

(57) ABSTRACT

An article security device for secure engagement of articles of varying sizes while maintaining product visibility and minimizing operational complexity. The article security device includes an article surveillance device, a hub, captive portions configured to engage with surface portions of an article, moveable members coupled to the captive portions and extending from the hub, the moveable members configured to slide or telescope linearly with respect to the hub, and a locking member configured to releasably lock lateral movement of the moveable members. The device may include cables constraining movement, channels in the hub for guiding travel paths, concave portions for corner engagement, and toothed or ridged profiles for locking engagement. The locking member may regulate movement independently for multiple moveable members and may be selectively released.

### CROSS REFERENCE TO RELATED APPLICATION

This application claims the benefit of U.S. Provisional Application No. 63/770,210 titled “ARTICLE SECURITY DEVICE” filed Mar. 11, 2025, which is incorporated by reference herein in its entirety.

### FIELD OF THE INVENTION

The present disclosure relates to systems and methods for securing articles in retail environments.

### BACKGROUND

The present disclosure relates generally to security devices and more specifically to a system for preventing the theft of articles of different sizes using a secure, adjustable article security device.

In retail environments, particularly within segments involving merchandise of substantial value, theft of premium items remains a persistent challenge for store operations and profitability. For instance, numerous security devices, such as electronic surveillance tags, locked display cases, and mechanical restraining devices, have been created to discourage unauthorized removal of merchandise. Nonetheless, many of these solutions demand considerable retailer effort for installation and removal, or detract from product design and branding. Additionally, the diverse range of sizes and shapes of consumer good complicates the implementation of a security system that accommodates various products while preserving visual presentation and display adaptability.

Traditional locked enclosures and wired security systems often demand manual adjustment or multiple device types to accommodate diverse articles, resulting in increased inventory costs and operational complexity. Frequently, retailers rely on bulky housings that conceal both the front and back of the merchandise, hindering customer interaction and depersonalizing the shopping experience. Electronic tags may trigger alarms but do not physically prevent removal. In addition, tagging solutions frequently require reconfiguration or specific tooling at the point of sale, thereby extending checkout times. As theft methods evolve, there remains a lack of a streamlined and adaptable security solution that combines unobstructed product visibility with rapid installation and removal. Accordingly, there is a need for an efficient security device that can adjust to articles of varying dimensions, minimize in-store labor, and preserve the aesthetic appeal of merchandise.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect of the present disclosure, an article security device comprises an article surveillance device, a hub, a first captive portion configured to engage with a first surface portion of an article, a second captive portion configured to engage with a second surface portion of the article, at least one moveable member coupled to the first captive portion and extending from the hub, wherein the at least one moveable member is configured to slide or telescope linearly with respect to the hub, and a locking member configured to releasably lock lateral movement of the at least one moveable member with respect to the hub.

According to an aspect of the present disclosure, an article security device comprises an article surveillance device, a hub, a first captive portion configured to engage with a first surface portion of an article, a second captive portion configured to engage with a second surface portion of the article, at least one moveable member coupled to the first captive portion and extending from the hub, wherein the at least one moveable member is configured to slide or telescope linearly with respect to the hub, a cable coupled to the first captive portion, and a locking member at the hub configured to releasably lock lateral movement of the cable with respect to the hub.

According to an aspect of the present disclosure, an article security device comprises an article surveillance device, a hub, a locking member, a first captive portion configured to engage with a first surface portion of an article, a second captive portion configured to engage with a second surface portion of the article, and at least one moveable member coupled to the first captive portion and extending from the hub, wherein the at least one moveable member is configured to slide or telescope linearly with respect to the hub, wherein the at least one moveable member comprises a portion having a toothed or ridged profile, and the locking member is configured to engage the toothed or ridged profile to regulate movement of the first captive portion.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a layout of a retail store facility, according to some aspects of the disclosure.

FIG. 2 illustrates a schematic view of an article security device, in accordance with some aspects of the present disclosure.

FIG. 3 illustrates a schematic view of the article security device secured to an article, in accordance with an aspect of the present disclosure.

FIG. 4 illustrates another schematic view of the article security device secured to the article of FIG. 3, in accordance with some aspects of the disclosure.

FIG. 5 illustrates a schematic view of an article security device for an article in a retail space, according to some aspects of the disclosure.

FIG. 6 illustrates another schematic view of the article security device of FIG. 5, according to some aspects of the disclosure.

FIG. 7 illustrates an inward displacement of the article security device of FIG. 5, according to some aspects of the disclosure.

FIG. 8 illustrates displacement of one of the clamps of the article security device of FIG. 5, according to some aspects of the disclosure.

FIG. 9 illustrates a schematic view of an article security device with angularly displaceable clamps, according to some aspects of the disclosure.

FIGS. 10 and 11 illustrate schematic views of an article security device in various states of operation according to some aspects of the disclosure.

### DETAILED DESCRIPTION

One or more specific aspects of the disclosure of the present disclosure will be described below. These described aspects of the disclosure are only examples of the presently disclosed techniques. Additionally, in an effort to provide a concise description of these aspects of the disclosure, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

### I. Terminology

When introducing elements of various aspects of the disclosure of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional aspects of the disclosure that also incorporate the recited features.

Throughout the disclosure, the term “substantially” or “approximately” may be used as a modifier for a geometric relationship between elements or for the shape of an element or component. While the terms substantially or approximately are not limited to a specific variation and may cover any variation that is understood by one of ordinary skill in the art to be an acceptable variation, some examples are provided as follows. In one example, the terms substantially or approximately may include a variation of less than 10 % of the dimension of the object or component. In another example, the terms substantially or approximately may include a variation of less than 5 % of the object or component. If the terms substantially or approximately are used to define the angular relationship of one element to another element, one non-limiting example of the terms may include a variation of 5 degrees or less. These examples are not intended to be limiting and may be increased or decreased based on the understanding of acceptable limits to one of ordinary skill in the art.

For purposes of the disclosure, directional terms are expressed generally with relation to a standard frame of reference when the devices described herein is installed and in an in-use.

The terms “first,” “second,” “third,” and “fourth” are used in this disclosure. It will be understood that, unless otherwise noted, those terms are used in their relative sense only. In particular, in some aspects certain components may be present in interchangeable and/or identical multiples (e.g., pairs). For these components, the designation of first, second, third, and/or fourth may be applied to the components merely as a matter of convenience in the description of one or more of the aspects of the disclosure.

The terms “disposed on,” “disposed along,” “disposed with,” or “disposed toward” and variations thereof may define one element can be integral with another element, or that one element can be a separate structure bonded to or placed with or placed near another element.

The term “at,” for example when referring to something being located at a specific location, is intended to include any one or more of: proximate, on, near, adjacent to or within the specific location. As used herein, the terms proximal is defined with respect to an object, element, or user. For example, the term proximal may refer to the part or portion closer to the user.

### II. Overview

This section is provided only as a high-level overview of certain features and concepts of the present disclosure. Detailed example implementations, alternative configurations, and other variations that are within the scope of the disclosure are described in further detail below.

This application describes a family of adjustable, reusable article security devices that physically restrain packaged merchandise (e.g., retail boxes) while keeping the front of the packaging visible. In general, the device includes a hub positioned on a rear surface of the article and multiple corner-engaging clamps that captively engage corners and/or edges so the product remains presentable on display.

In one set of examples, the clamps are moved by one or more cables routed from the hub to the clamps. A cable driver inside the hub winds and unwinds the cable(s) to tighten the clamps onto the article and to release them for authorized removal (for example, using a magnetic detacher and a lock mechanism such as a ratchet-and-pawl). A spring associated with the cable driver may help take up slack and maintain tension, including examples where a user pulls clamps outward against spring force and then releases them to let the device snug onto the article, or examples where clamps start extended and the user presses them inward until the mechanism locks.

In other examples, clamp movement is controlled by a gear- or rack-based mechanism (e.g., engaging a toothed/undulating profile on an extendable/retractable portion) that allows clamps to translate inward and outward and lock at selected positions. The device may support simultaneous clamp movement for quick fitting of symmetric packages and/or selective movement of one clamp relative to others to accommodate non-standard shapes.

The disclosure also describes versions that allow angular repositioning of clamps around the hub (in addition to radial movement) to fit different aspect ratios (e.g., square vs. rectangular). The devices may further include security features usable with store systems, such as EAS and/or RFID, optional wireless signaling, and tamper detection (e.g., cable continuity, tension, or position monitoring), with optional local alarms and event logging

### III. Detailed Examples

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form to avoid obscuring such concepts.

Implementations of the present disclosure provide a security or safe device. The device will be described in the following detailed description and illustrated in the accompanying drawings by various modules, blocks, components, processes, among other examples (collectively referred to as “elements”).

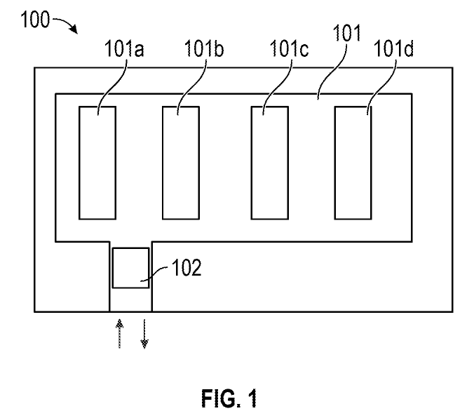

Referring now to FIG. 1, a layout of a retail store facility 100 is shown, according to some aspects of the disclosure. The retail store facility 100 is shown to include a retail section 101 having one or more sections for display and/or sale of articles or other consumer goods. In an aspect of the disclosure, as some non-limiting examples, retail section 101 may correspond to a fashion department of the retail store facility 100. Section 101a may relate to menswear section, section 101b may relate to womenswear section, section 101c may relate to kids wear section, and section 101d may relate to section having articles which are required for daily needs and/or accessories e.g., handkerchiefs, caps, handbags, wallets, belts, perfumes, electronics, cosmetics, and the like.

One or more customers may enter and/or exit the retail store facility 100 through a gateway 102. The retail store facility 100 is shown to have a gateway 102 at the entrance and exit, however the retail store or facility may have one or more entrance(s) and/or exit(s). The retail store may have gateways(s) 102 that correspond with each entrance and/or exit.

Though the retail section 101 is shown and described as a fashion wear outlet, the retail section 101 is not limited to only fashion departments and may include an outlet for any retail products, e.g., furniture, kitchenware, electronics, and the like. In some aspects of the disclosure, the retail section 101 may correspond to a section of retail establishments like amusement parks, malls, multiplexes, and the like.

In some examples useable with the aspects of the disclosure described below, retail store facility 100 may include a retail security and/or tracking system configured to detect, identify, and/or track articles that traverse (e.g., enter, exit, or attempt to exit) the retail store facility 100 through gateway 102. The retail security and/or tracking system may be implemented in any suitable architecture, including a standalone system localized to the retail store facility 100, a multi-store system managed by a centralized server, and/or a hybrid system. The retail security and/or tracking system may include one or more detection units disposed at and/or proximate gateway 102, one or more article-associated devices coupled to articles offered for sale (e.g., a security tag, a label, a tethered device, and/or an article security device as described herein), and one or more controllers configured to process signals generated by the detection units and to generate an alert and/or an event log responsive to determining an unauthorized exit condition.

Gateway 102 may include one or more pedestals, frames, or overhead structures that define an interrogation zone. The interrogation zone may be established across an entry/exit path (e.g., between opposing pedestals, between a pedestal and a wall-mounted antenna, between an overhead antenna and a floor antenna, or any combination thereof). The interrogation zone may be configured such that an article-associated device transitions from a non-detected state to a detected state when carried by a customer across a threshold plane associated with gateway 102. In some embodiments, the interrogation zone includes multiple sub-zones to support direction-of-travel determination (e.g., entry vs. exit) by detecting a sequence of detections along a travel path.

The retail security and/or tracking system may be implemented as an electronic article surveillance (EAS) system. For example, an article may carry an RF EAS label or an acousto-magnetic (AM) EAS marker, and gateway 102 may include an RF transmitter/receiver and/or an AM transmitter/receiver that energizes the marker and detects a response. In one example, gateway 102 includes opposing pedestals each including one or more loop antennas, and a controller drives the loop antennas to generate an electromagnetic field and monitors for a response characteristic of an active EAS marker. In another example, gateway 102 includes one or more overhead antennas configured to improve detection of articles carried above waist level or concealed within bags. In some embodiments, the controller determines that an alarm condition exists when the response from the marker meets one or more criteria, such as amplitude above a threshold, a signature consistent with an active marker, and/or detection in multiple successive transmit cycles.

The retail security and/or tracking system may be configured as a radio frequency identification (RFID) system. Articles may include RFID tags (e.g., UHF EPC tags), and gateway 102 includes one or more RFID readers and antennas configured to read identifiers from tags moving through the interrogation zone. A controller may then compare the read identifier(s) to an inventory database and/or an active transaction list to determine whether the article is authorized to exit. In one example, an RFID tag read at gateway 102 is cross-referenced to a POS transaction that includes the same identifier; if no match is found, an alert is generated. The RFID system may support item-level identification (e.g., EPC/serialized identifiers) enabling detection of a specific SKU, a specific serial number, and/or a batch/lot identifier.

The retail security and/or tracking system usable with aspects of this disclosure may further include a hybrid EAS/RFID tag and corresponding gateway 102 hardware configured to detect both an EAS function and an RFID function. For example, an item may include a dual-technology label providing an EAS alarm feature while also providing an RFID identifier for inventory and analytics. The controller may rely on the EAS feature for theft detection and the RFID feature to identify the article(s) involved in an alarm event. In one example, upon an EAS alarm, the gateway 102 system triggers an RFID read burst to capture identifiers of tags present in the interrogation zone, thereby associating one or more item identifiers with the alarm event.

In some examples, the retail security and/or tracking system may include one or more magnetic and/or mechanical detection features associated with a reusable security device (e.g., connected to the security devices described below. For example, an article security device may include a magnetic lock configured to be unlocked at checkout via a detacher or magnetic key. The system may include a sensor configured to detect whether the lock remains in a locked state as the article traverses gateway 102. For instance, the article security device may include a reed switch, Hall-effect sensor, or magnetometer configured to output a lock-state signal, and the gateway 102 controller may determine an unauthorized exit condition when a locked-state device is detected in the interrogation zone.

In some embodiments, the article security device includes a conductive cable, a loop, and/or one or more conductors configured as an antenna and/or continuity loop. In such embodiments, the device may include a continuity monitoring circuit configured to detect cutting, severing, or abnormal stretching of the cable(s) of the security device described below (e.g., cables 208, 1008) In one example, the device includes a circuit that measures resistance, capacitance, and/or inductance of a cable path, and triggers a local alarm (e.g., audible beeper) and/or transmits an alert to the store system when the measured value deviates beyond a threshold. In some embodiments, the gateway 102 system may also detect the device via a transmitted identifier or via an EAS response while the local alarm is active, thereby enabling correlation of the event to a specific exit attempt.

In some example implementations, the retail security and/or tracking system includes a wireless communications subsystem, such as Bluetooth Low Energy (BLE), Wi-Fi, Zigbee, LoRa, UWB, NFC, and/or a proprietary RF protocol. In such embodiments, the article-associated device may periodically transmit an advertisement packet including an identifier and/or status (e.g., locked/unlocked, cable tension status, tamper state, battery level). In some embodiments, gateway 102 includes one or more receivers that detect the wireless transmissions within a geofenced perimeter proximate the exit. In one example, the system determines an exit attempt when a device’s signal strength increases across a threshold while the device remains in a locked state. In another example, two receivers positioned on opposite sides of gateway 102 are used to estimate direction-of-travel by comparing time-of-arrival and/or received signal strength indicators.

In some examples, the retail security and/or tracking system includes computer vision and/or video analytics. For example, retail store facility 100 may include one or more cameras oriented toward gateway 102 and configured to capture images of individuals and/or articles passing through. In some embodiments, the system performs object detection to identify an article, a box, or a secured article form factor, and correlates the detected object with an alarm event from an EAS/RFID subsystem. In one example, upon an alarm, the system bookmarks video from a time window around the alarm, records a clip, and associates the clip with an event record. In some embodiments, the system performs people counting, line-crossing analytics, and/or trajectory tracking to determine whether a person carrying an article crossed the exit threshold.

The retail security and/or tracking system may include audible and/or visible annunciators. For example, upon detection of an unauthorized exit condition, the system may activate a siren, a buzzer, a voice prompt, and/or a strobe light at gateway 102. In some examples, the alert is tiered, such as a local alert at gateway 102 and a remote alert to store personnel devices. In some examples, the system transmits notifications to a handheld device carried by store associates (e.g., a smartphone or dedicated scanner), including an alarm type, an estimated item identifier, an associated camera snapshot, and/or an exit location identifier.

In some example implementations, the retail security and/or tracking system includes event logging and analytics. In such embodiments, the controller stores an event record including, by way of non-limiting example, a timestamp, gateway identifier, alarm type (RF EAS, AM EAS, RFID mismatch, tamper), measured signal metrics (e.g., RSSI, read rate, antenna used), associated tag/device identifier(s), and/or correlation to POS data. The system may generate reports identifying alarm frequency by time of day, by department (e.g., sections 101a-101d), by gateway, and/or by SKU category. The system may also flag repeated alarms from a particular device identifier as indicative of a malfunctioning tag or improper deactivation.

As noted above, the retail security and/or tracking system may include multiple gateways 102 distributed across entrances and exits, including main entrances, mall entrances, emergency exits, staff-only doors, and receiving doors. Each gateway 102 may be configured with an associated sensitivity profile based on expected traffic and risk (e.g., higher sensitivity near a high-theft department).

While retail environments are provided as examples above, the retail security and/or tracking system may instead be implemented in environments other than traditional retail stores, including, by way of non-limiting example, warehouses, fulfillment centers, libraries, equipment rooms, amusement parks, multiplexes, and/or kiosks, where gateway 102 corresponds to a monitored passage. In some examples, the same system logic is used to detect unauthorized removal of controlled assets, including electronics, tools, rental equipment, and/or event merchandise.

The retail security and/or tracking system may further include a deactivation and/or detachment workflow. For instance, at a point-of-sale (POS) station, an associate may deactivate an EAS label (e.g., by applying a deactivation field) and/or detach a reusable security device as described in detail below from an article. In some example implementations, the system associates a deactivation event with a transaction identifier, a timestamp, a checkout lane identifier, and/or an operator identifier.

It should be understood that the foregoing examples are non-limiting, and that retail store facility 100 and gateway 102 may implement any combination of EAS, RFID, wireless beacons, mechanical/tamper sensors, video analytics, and/or other sensing abilities to detect and/or track articles with a security device connected thereto have any one or combination of the features described below leaving the retail store facility 100, and to generate alerts and records responsive thereto.

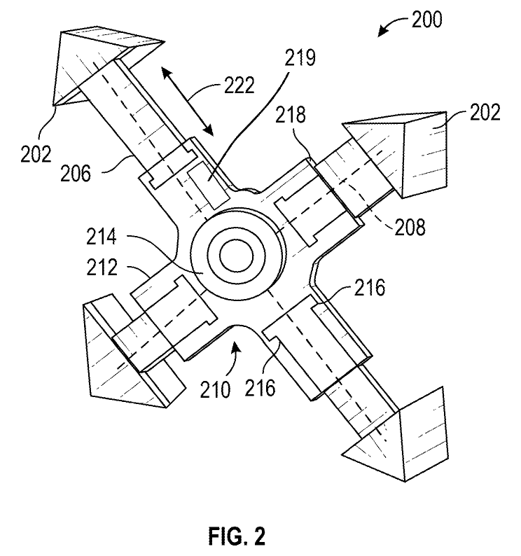

Referring now to FIG. 2, in accordance with some aspects of the disclosure of the present disclosure, an article security device 200 is disclosed. The security device 200 includes a hub portion 210, captive portions 202 (which may hereinafter be interchangeably referred to as clamp members), a tensioning/locking member 214 (which may hereinafter be interchangeably referred to as a cable driver), and a plurality of cables 208.

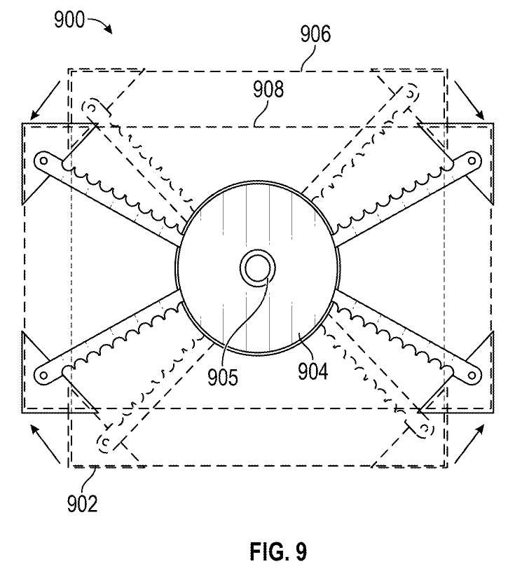

The hub 210 portion may be formed as a housing with one or more (four in the example shown in FIG. 2) extendable/retractable portions 206 that are configured to extend into and out-of (e.g., in directions 222) respective extension(s) 212 of the hub. While an “X” shaped configuration of the extensions 212 is shown in FIG. 2 the shape of the hub 210 may be selected from, but not limited to, star shape, delta shape, asterisk shaped, snowflake shaped, ‘X’ shaped, and ‘Y’ shaped. In some other aspects of the disclosure, the shape of the hub 210 can be any geometric or non-geometric shape that is symmetrical or asymmetrical. The count of the plurality of extensions 212 may be in multiples of two or from 3-10 extensions without departing from the scope of the disclosure. In some other aspects of the disclosure, the hub 210 may be provided with a mechanism (explained with reference to FIG. 9) to facilitate angular displacement of at least one of the extendable/retractable portions and respective captive portions 202.

Each one of the plurality of extensions 212 may comprise an opening or slot that corresponds with and/or is slightly larger than the outer dimensions of extendable/retractable portions 206 so that each extendable/retractable portion 206 are substantially constrained in all directions except linearly out of and into each respective one of the plurality of extensions 212 (e.g., in direction 222). In some non-limiting examples, the opening or slot is defined by opposing sidewalls that serve as guide rails and that limit lateral translation and yaw of the extendable/retractable portion 206 while permitting sliding movement along direction 222. In some examples, the opening or slot includes one or more low-friction features, such as a rounded lead-in chamfer, a radiused edge, a bushing, a sleeve, a liner, and/or a bearing surface formed from a polymeric material, to reduce binding and to promote smooth extension and retraction. In some examples, the opening or slot has a non-circular profile selected to prevent rotation of the extendable/retractable portion 206 about its longitudinal axis, such as a rectangular profile, a D-shaped profile, an oval profile, a keyway-and-key profile, or a splined profile. In some examples, the opening or slot includes a detent feature and/or one or more index recesses configured to provide tactile feedback and/or incremental positioning of the extendable/retractable portion 206 relative to the hub 210.

The extension 212 may further define an internal passage having a stepped cross-section, such that a first region proximate the hub 210 provides a tighter guidance tolerance and a second region proximate the free end provides clearance to accommodate manufacturing tolerances, debris, and/or cable routing. In some examples, the opening or slot includes one or more retention lips, tabs, or restricting members 218 that cooperate with one or more protrusions 216 on the extendable/retractable portion 206 to limit outward travel and prevent removal of the extendable/retractable portion 206 from the hub 210. In some examples, the extension 212 includes an end cap or insert that partially closes the opening or slot while still permitting linear travel of the extendable/retractable portion 206 and passage of a corresponding cable 208.

In some examples, the extension 212 includes an internal channel configured to route the cable 208 alongside, above, below, and/or through a portion of the extendable/retractable portion 206, thereby maintaining a desired cable path and reducing snagging against the article surface. In some examples, the channel is defined by a groove, tunnel, or covered raceway, and may include a curved or radiused turn proximate the opening or slot to reduce cable wear. In some examples, the extension 212 includes one or more guides, rollers, posts, or eyelets configured to maintain cable alignment during winding and unwinding by the tensioning/locking member 214.

The extendable/retractable portion 206 may be configured as a telescoping assembly, in which the extendable/retractable portion 206 includes multiple nested sections that translate relative to one another while remaining guided by the opening or slot of the extension 212. In some examples, the extension 212 includes one or more stops, shoulders, or interference features to define a minimum retracted position and/or to prevent over-insertion that could interfere with components of the tensioning/locking member 214. In some examples, the extension 212 includes a sealing feature, such as a wiper, of flexible skirt, configured to reduce ingress of dust and debris into the hub 210 while allowing linear movement of the extendable/retractable portion 206.

In some examples, the extension 212 is formed as an integral portion of the hub 210, and in other examples, the extension 212 is a separate component coupled to the hub 210 by fasteners, ultrasonic welding, adhesives, snap-fit features, and/or a bayonet interface, thereby enabling different extension geometries and/or lengths to be used with a common hub 210. Further, as shown in the examples below, the extension(s) 212 may pivot with respect to the hub (e.g., as described below with respect to FIG. 9) allowing for accommodation of various proportions of articles.

In some examples, each extendable/retractable portion 206 terminates at a captive member 202 (also referred to herein as a head) configured to captively engage a portion of an article, such as a corner, an edge, a flange, a rim, or a peripheral lip of a retail box or other packaged product. In some examples, the captive member 202 is sized such that, when installed, the captive member 202 occupies only a small corner region of the article to preserve visibility of front-facing branding, graphics, and product information while still providing mechanical restraint against removal.

The captive member 202 may be coupled to the extendable/retractable portion 206 as a unitary (e.g., single-piece) structure, or may be coupled as a separate component (e.g., by snap-fit features, ultrasonic welding, adhesives, rivets, screws, pins, or other mechanical fasteners). The captive member 202 may be configured to distribute clamping loads to reduce damage to packaging and to resist disengagement caused by pulling, twisting, or prying.

The captive member 202 may be configured as a corner-receiving pocket having two intersecting interior faces configured to register against adjacent sides of the article near a corner. The pocket may be defined by a pair of planar walls arranged at approximately a right angle, by curved walls, or by a compliant structure configured to conform to different corner radii. The pocket may include a lead-in chamfer, a flared mouth, and/or radiused edges to facilitate sliding the pocket over the corner during installation. The captive member 202 may include one or more retention lips that wrap at least partially around the corner to inhibit removal in a direction normal to the article surface.

In some examples, the captive member 202 includes a hook-like geometry configured to engage an underside of a corner region (e.g., a bottom edge or a rear edge), such that an engagement portion extends around the corner and retains the article by interference. The hook-like geometry may include a return flange, a barb, a cantilevered finger, or a resilient latch that deflects during installation and springs back to a retaining position once seated on the corner. The resilient latch may be integrally molded with the captive member 202 or may be formed as a separate insert coupled to the captive member 202. The captive member 202 may include a U-shaped or C-shaped channel configured to receive an edge of the article. The channel may include opposing jaws separated by a gap sized to receive a thickness of a box wall, a blister card, a product housing, or an edge of packaging. The jaws may be rigid, semi-rigid, or compliant. The channel may include a textured surface, ribs, ridges, serrations, or a high-friction insert (e.g., elastomer) to increase retention without requiring puncture or adhesive attachment to the article.

In some examples, the captive member 202 includes a multi-surface clamp that engages both a rear surface and one or more side surfaces of the article. For example, the captive member 202 may include a rear-facing pad configured to contact the rear surface of the article and one or more side-facing pads configured to contact adjacent side surfaces, such that tightening (e.g., cable winding) increases normal force between the pads and the article. The pads may be formed from a compliant polymer, rubber, foam, or overmolded elastomer to reduce marring, to improve grip, and to accommodate manufacturing tolerances of the article. The enclosure of each captive member 202 may include a partial shroud that covers an exterior tip of the corner while leaving the majority of the front face of the article visible. The enclosure may include one or more apertures to reduce material usage and to provide visual access to the corner region. The captive member 202 may be transparent or translucent to preserve visual presentation of packaging and branding.

In some examples, the captive member 202 includes a pivot joint relative to the extendable/retractable portion 206 to facilitate angular alignment with different article geometries. For example, the captive member 202 may be coupled by a pin joint, a living hinge, a ball-and-socket joint, or a flexure that allows the captive member 202 to rotate about one or more axes so that the corner-receiving pocket remains seated while the extendable/retractable portion 206 is oriented differently relative to the hub 210. The pivot joint may include a detent, friction fit, or stop surfaces to maintain the captive member 202 within a range of motion and to reduce undesired flopping during handling.

The captive member 202 may include an opening, eyelet, or fairlead to route a corresponding cable 208. For instance, the cable 208 may pass through a passage formed in the captive member 202 and/or may be anchored to the captive member 202, such that winding and unwinding by the cable driver 214 adjusts tension and draws the captive member 202 toward or away from the hub 210. The cable 208 may be coupled to the captive member 202 via a crimp, knot, swage, molded-in anchor, ball-end fitting, ferrule, or captured pin. In some examples, the captive member 202 includes an internal cavity configured to conceal a portion of the cable 208 or an anchor point to reduce access for cutting.

In some examples, the captive member 202 includes one or more compliance features that permit limited deflection under load. For example, the captive member 202 may include a spring arm, a resilient tongue, or an elastomeric insert that deflects to accommodate various corner geometries. The compliance feature may also reduce peak stress on the article and reduce the likelihood of tearing or crushing packaging. The captive member 202 may be configured to captively engage articles having non-rectangular profiles. For example, the captive member 202 may include a widened mouth, a rounded pocket, or interchangeable inserts configured to engage corners having angles other than 90 degrees (e.g., acute or obtuse corners of a polygonal package). The captive member 202 may include a slotted capture region that accommodates different corner chamfers and/or beveled edges.

In some example implementations, one or more of the extendable/retractable portions 206 are naturally biased toward an outward or extended position relative to the hub 210. In such embodiments, the article security device 200 may be configured such that a user urges (e.g., presses) one or more of the extendable/retractable portions 206 inward toward the hub 210 to reduce an overall reach of the device for placement on an article, and then locks the extendable/retractable portions 206 in place to maintain engagement of the captive portions 202 with corresponding corners and/or edges of the article. Conversely, upon release of the lock (e.g., via a detacher, a magnetic key, and/or other authorized unlocking operation as described below), the bias may drive the extendable/retractable portions 206 outward to increase the reach of the device and facilitate removal from the article and/or to take up slack during application.

In some non-limiting examples, the outward bias is provided by one or more springs disposed within the hub 210 and/or within the extensions 212, such as coil springs arranged along a longitudinal axis of the extendable/retractable portions 206, torsion springs coupled to a pivot joint (e.g., between the head 202 and the extendable/retractable portion 206), constant-force springs, leaf springs, elastomeric members, and/or resilient polymer flexures. In some examples, each extendable/retractable portion 206 includes a spring element acting between the hub 210 and the extendable/retractable portion 206 to urge the extendable/retractable portion 206 toward an extended position. In some examples, a common spring element acts on multiple extendable/retractable portions 206, for example via a ring, yoke, or linkage disposed within the hub 210 that distributes an outward bias force to a plurality of extensions 212. The outward travel of each retractable portions 206 is limited by cooperation of protrusions 216 and restricting members 218, thereby defining a maximum reach in the extended state while preventing removal of the extendable/retractable portions 206 from the extensions 212.

The outward bias may also facilitate usability by causing the clamps 202 to move outward when the device is not installed on an article, thereby presenting the captive portions 202 in an open configuration for quicker placement on corners or otherwise improve convenience with regard to installing the security device 200 on to a device or article.

The hub 210 may house a tensioning/locking member 214 (also referred to herein as a cable driver) configured to control extension and retraction of one or more cables 208 and, as a result, to regulate displacement of one or more extendable/retractable portions 206 and captive members 202 relative to the hub 210. In use, the cable driver 214 may selectively wind the cable(s) 208 onto one or more spools to draw the captive members 202 inward toward the hub 210 (e.g., to tighten the device around an article), and may selectively unwind the cable(s) 208 to allow the captive members 202 to move outward (e.g., to release the device from the article), including under an outward bias of the arms and/or clamp structures described herein.

In an example implementation consistent with reusable retail “spider wrap” style devices, the cable driver 214 may include at least one spool rotatably supported within the hub 210 and a lock configured to prevent rotation of the spool in an unwinding direction while the device is secured to an article. The lock may be implemented as a ratchet-and-pawl mechanism in which a pawl engages teeth of a ratchet coupled to the spool to allow winding while blocking unwinding. The lock may be releasable by an authorized detacher, such as a magnetically-actuated detacher commonly used at point-of-sale, where a magnetic field displaces a latch element and permits the spool to rotate freely (or permits controlled unwinding) to enable removal of the device. In other example implementations, the locking function may be implemented by a cam, wedge, or brake element that clamps a spool shaft or frictionally engages a spool flange to resist unwinding until released by an authorized unlocking operation.

The cable driver 214 may be configured to operate with a plurality of cables 208 (e.g., one cable per extension 212) or with at least one cable routed as a loop that passes through or around multiple clamps. For instance, an example implementation may employ four separate spools and four corresponding cables, each cable being coupled to a respective clamp so that winding draws each clamp inward. Another example implementation may employ a single cable loop routed through channels of multiple clamps and returning to the hub 210, such that winding reduces an effective loop size and draws the clamps inward collectively. A further example implementation may employ two cable loops (e.g., an upper loop and a lower loop around the article) to increase stability on tall packages, to distribute load, and/or to reduce the likelihood of tilting of one or more clamps during tightening.

The cable driver 214 may be configured to adjust the clamps collectively or selectively. In a collective mode, the cable driver 214 may wind and unwind the cable(s) so that the clamps move inward or outward substantially simultaneously, which may be suitable for square or otherwise symmetric articles. In a selective mode, the cable driver 214 may permit independent adjustment of one cable (or a subset of cables) relative to the remaining cables, which may be useful for rectangular articles, non-rectangular articles, or articles in which corner distances from the hub 210 are unequal. For example, the cable driver 214 may include a selector that couples a user input (e.g., a knob or key interface) to a selected spool, while other spools remain locked, thereby allowing the user to tighten one corner region without changing a previously set corner region.

The cable driver 214 may be manually actuated or may include a biasing element. In one example implementation, a user rotates a knob, dial, key interface, or tool interface accessible at the hub 210 to wind the spool(s). In another example implementation, the cable driver 214 includes an auto-retracting mechanism, such as a clock spring coupled to the spool, that applies torque tending to wind the cable(s) and take up slack. In such a configuration, the device may be applied by positioning the captive members 202 on corners and allowing the biasing element to draw the cables taut, after which a lock engages to hold a selected tension. In still other example implementations, the bias may be arranged to assist unwinding (e.g., to open the device upon unlocking) while a separate user actuation provides winding to tighten around an article.

The cable driver 214 may be configured to limit tightening force and/or to promote securement across articles with varying dimensions. For example, the cable driver 214 may include a slip clutch, a torque limiter, a compliant spring element, and/or an over-travel stop configured to limit maximum cable tension to reduce damage to packaging. The cable driver 214 may also include an audible or tactile feedback feature, such as a clicking ratchet sound, detent positions, or an indicator window, to indicate progress of tightening and/or a locked state.

The cable driver 214 may cooperate with other structures described herein to reduce tampering. For example, the spool(s), ratchet, and latch elements may be enclosed within the hub 210 to reduce access by cutters or prying tools. The cable driver 214 may route the cable(s) through protected passages of the hub 210 and extensions 212 and may maintain cable alignment via guides, eyelets, or rollers to reduce abrasion during winding and unwinding. The cable driver 214 may further cooperate with one or more security features 219, such as a lock-state sensor (e.g., reed switch or Hall sensor responsive to a magnet position), a spool rotation sensor (e.g., encoder), and/or a tension or continuity monitoring circuit coupled to a conductive cable, thereby enabling the retail security/tracking system at gateway 102 to detect a locked device, detect tamper, and/or correlate an alarm to a particular device identifier.

Although described primarily in the context of cable winding, the tensioning/locking member 214 may additionally, or alternatively, drive other actuation mechanisms consistent with the disclosure. For example, the tensioning/locking member 214 may lock and unlock a central gear that engages rack features (e.g., a rack-and-pinion arrangement) such that rotation of a gear advances multiple clamp tails simultaneously or in any combination (as described in further detail below).

It should be understood that the foregoing description of the cable driver 214 is non-limiting, and that the cable driver 214 may include any combination of spools, biasing elements, selectors, locks, detacher interfaces, and sensing elements configured to facilitate controlled winding and unwinding of the cable(s) 208 and secure retention of the captive members 202 on an article.

As noted above, in some examples the retractable portions 206 and captive members are biased in an outward direction to facilitate ease of installation and removal of the security device 200 from an article. In some example implementations, the biasing is implemented via the cable driver 214. For example, the cable driver 214 may include one or more spools coupled to a spring (e.g., a clock spring) configured to apply torque that tends to unwind and thereby allow the cables 208 to press outward out, which in turn permits the extendable/retractable portions 206 to move outward. In other embodiments, the cable driver 214 includes a spring configured to wind the cables 208 (e.g., to retract or tighten), while separate biasing elements urge the extendable/retractable portions 206 outward such that the final position is determined by an equilibrium between cable tension and the outward bias. In some examples, the device includes a user-actuatable release that temporarily decouples one or more spools from a ratchet-and-pawl so that the bias may move the extendable/retractable portions 206 outward during installation and/or removal.

In some examples, the device includes a locking mechanism configured to hold one or more extendable/retractable portions 206 at a selected inward position against the outward bias. The locking mechanism may be implemented by the tensioning/locking member 214 and restrict cable movement to maintain cable tension that holds the extendable/retractable portions 206 inward. In some examples, the locking mechanism includes a ratchet-and-pawl arrangement that permits inward movement of the extendable/retractable portions 206 (e.g., by allowing winding of the cables 208) while preventing outward movement until authorized unlocking occurs. In some examples, the locking mechanism includes a magnetically releasable latch configured to be unlocked by a detacher, thereby permitting the outward bias to extend the extendable/retractable portions 206.

In some example implementations, the cable driver 214 is configured such that the user may press all of the extendable/retractable portions 206 inward substantially simultaneously to fit the device around an article, and then actuate a lock to maintain the inward positions. In other embodiments, the device permits independent inward pressing and locking of individual extendable/retractable portions 206, for example to accommodate non-rectangular articles and/or articles having corners not equidistant from the hub 210, consistent with selective clamp displacement described herein.

The hub 210 (or any other part of the security device 200) may include one or more security feature(s) 219. The security feature 219 may be configured to cooperate with, be detectable by, and/or communicate with any security or tracing system including but not limited to the retail security and/or tracking system of retail store facility 100 at gateway 102, as described above. For example, security feature 219 may include an electronic security element configured to generate a detectable response when within an interrogation zone of gateway 102. For example, the security feature 219 may include an electronic article surveillance (EAS) element selected from an RF EAS element, an acousto-magnetic (AM) element, or a dual-technology element. In some examples, the security feature 219 includes or is coupled to at least one antenna, and the antenna may be disposed in the hub 210, within an extension 212, within one or more clamp members 202, and/or partially implemented by one or more of the cables 208 (e.g., by configuring a cable 208 as a conductive element and/or as part of a resonant structure). In some embodiments, the security feature 219 includes a radio frequency identification (RFID) tag, such as a UHF EPC RFID tag, configured to provide an item identifier, a device identifier, and/or a serialized identifier that may be read by a reader at gateway 102 and compared to an inventory database and/or a point-of-sale authorization record. Additional non-limiting examples of the security feature include any device configured to cooperate with, be detectable by, and/or communicate with any of the systems described above with respect to FIG. 1.

It should be understood that the security feature 219 may include any one or combination of the foregoing features, and that the security feature 219 may be implemented within the hub 210, within an extension 212, within one or more clamps 202, within the cable driver 214, and/or distributed across multiple components of the security device 200, while remaining detectable by and/or interoperable with the retail security and/or tracking system of retail store facility 100 at gateway 102.

The security feature 219 may include a locking and/or release interface configured for authorized detachment at a point-of-sale station. In some examples, the locking and/or release interface includes a magnetically-actuated lock configured to be unlocked by a detacher, magnetic key, or detacher pad. In some examples, the locking mechanism is configured as a ratchet-and-pawl arrangement coupled to the cable driver 214 and configured to prevent unwinding of one or more spools while locked. In some embodiments, the security feature 219 includes a lock-state sensor configured to provide an electronic indication of whether the device is locked. For example, the lock-state sensor may include a reed switch, Hall-effect sensor, magnetometer, micro-switch, optical interrupter, and/or conductive contact, and the lock-state sensor may be monitored by a controller within the hub 210 and/or reported to gateway 102 via EAS/RFID/wireless communications.

The security feature 219 may include a tamper detection subsystem configured to detect cutting, severing, abnormal stretching, or unauthorized manipulation of one or more cables 208 and/or other structural elements. For example, the security feature 219 may include a continuity monitoring circuit configured to measure resistance, capacitance, and/or inductance of a conductive path formed by a cable 208 and to determine a tamper condition when a measured value deviates beyond a threshold. In some examples, the security feature 219 includes a tension sensor, such as a strain gauge, load cell, spring deflection sensor, or motor current sensing of the cable driver 214, configured to detect abnormal changes in cable tension indicative of prying, forced removal, or cutting. In some examples, the security feature 219 includes a position sensor configured to detect displacement of one or more clamp members 202 and/or extendable/retractable portions 206 beyond a threshold, including a rotary encoder associated with the cable driver 214, a linear encoder, a potentiometer, an optical sensor, and/or a magnetic sensor.

The security feature 219 may also include one or more alarm outputs configured to provide a local deterrent and/or to assist personnel. For example, the security feature 219 may include an audible transducer (e.g., a beeper or siren), a visual indicator (e.g., an LED or strobe), and/or a vibration motor. In some examples, the local alarm is triggered responsive to detecting a tamper condition and/or responsive to determining that the device is in a locked state while within a geofenced zone proximate gateway 102. In some embodiments, the security feature 219 includes memory configured to store an event log, such as lock/unlock events, tamper events, battery events, and/or gateway detections, and such information may be retrievable by a detacher, a handheld reader, and/or gateway 102.

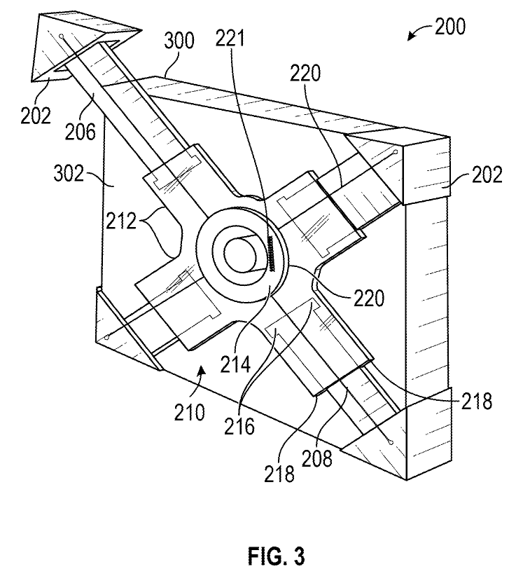

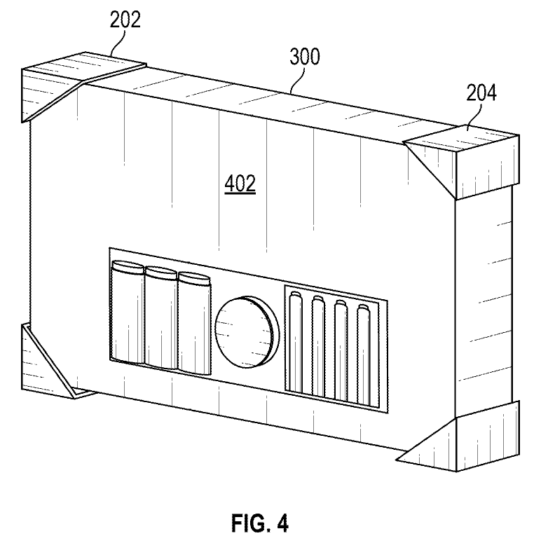

Now referring to FIGS. 3 and 4, the article security device 200 of FIG. 2 is shown installed on an article 300. The security device 200 may be applied such that the hub 210 is positioned along a rear surface 302 of the article 300 while the captive portions 202 are seated at respective corner regions of the article 300. The hub 210 may be located generally at or near a central region of the rear surface 302 to provide substantially symmetric reach of the captive portions 202 toward the corners; however, the hub 210 may be offset from the center based on the geometry or dimensions of the article.

During installation, a user may position the captive portions 202 proximate the corners of the article 300 and actuate the cable driver 214 to take up slack in the cables 208 and draw the captive portions 202 into captively engaged contact with the corners. As shown, the plurality of cables 208 may extend diagonally across the rear surface 302 between the hub 210 and the respective captive portions 202, thereby leaving a front surface 402 (FIG. 4) substantially unobstructed for viewing of branding, graphics, and product information. In use, winding of the cables 208 by the cable driver 214 may reduce an effective cable length and increase tension, thereby pulling the captive portions 202 inward toward the hub 210 and maintaining secure retention of the device 200 on the article 300. Conversely, authorized unlocking of the cable driver 214 may permit controlled unwinding of the cables 208 to reduce tension and allow the captive portions 202 to disengage from the corners for removal.

In one example implementation, the spring 221 associated with the cable driver 214 provides a bias that a user may temporarily overcome during installation. For example, the user may grasp one or more captive portions 202 and pull the captive portions 202 outward (e.g., away from the hub 210 and/or along direction 222) against a spring force produced by the spring 221 to increase an overall reach of the device 200, position the captive portions 202 around corner regions and/or along adjacent edges of the article 300, and then release the captive portions 202. Upon release, the spring 221 may act through the cable driver 214 to retract slack and draw the cables 208 taut, thereby urging the captive portions 202 into captively engaged contact with the edges and/or corners of the article 300 while the cable driver 214 maintains tension.

In another example implementation, the captive portions 202 (and/or extendable/retractable portions 206) are naturally in an extended position, such as due to an outward bias provided by the spring 221 through the cable driver 214 and/or due to one or more biasing elements associated with the extensions 212 or portions 206. In such an arrangement, the device 200 may be placed on the rear surface 302 with the captive portions 202 aligned with the corners of the article 300, and the user may press one or more of the captive portions 202 inward toward the hub 210 to seat the captive portions 202 over the corners and increase cable tension. The cable driver 214 may then lock (e.g., by a ratchet-and-pawl and/or other locking mechanism described herein) to hold the captive portions 202 at the pressed-in positions against the corners of the article 300. After locking, the captive portions 202 may remain retained on the corners against the bias toward the extended position until an authorized unlocking operation permits the cable driver 214 to unwind and the captive portions 202 to move outward for removal.

In connection with the foregoing installation examples, and as shown in FIG. 3, the device 200 includes a spring 221 associated with the cable driver 214. The spring 221 may be configured to bias the cable driver 214 and/or one or more spools of the cable driver 214 to apply a preload to the cables 208. For example, the spring 221 may be a clock spring coupled to a spool such that the spring 221 urges the spool toward a winding direction to automatically take up slack when a user releases a pulled-out captive portion 202 and to maintain a selected tension after tightening. In another example, the spring 221 may bias the spool toward an unwinding direction such that, after authorized release of a lock, the spring 221 assists payout of the cables 208 to open the device 200 and facilitate removal from the article 300. In either case, the spring 221 may cooperate with a locking function of the cable driver 214 (e.g., a ratchet-and-pawl or a magnetically releasable latch as described herein) so that, when locked, the cable driver 214 resists unwinding and maintains cable tension that holds the captive portions 202 in a captively engaged state on the article 300.The hub 210 may be positioned on the rear surface 302 to maximize visibility of the article 300 from the front surface 402 while also discouraging tampering by placing the cable driver 214 and cable routing primarily on the rear side of the article. In addition, a substantial portion of the article security device 200, including portions of the hub 210, extensions 212, and/or captive portions 202, may be transparent or translucent to further reduce visual obstruction and preserve product presentation.

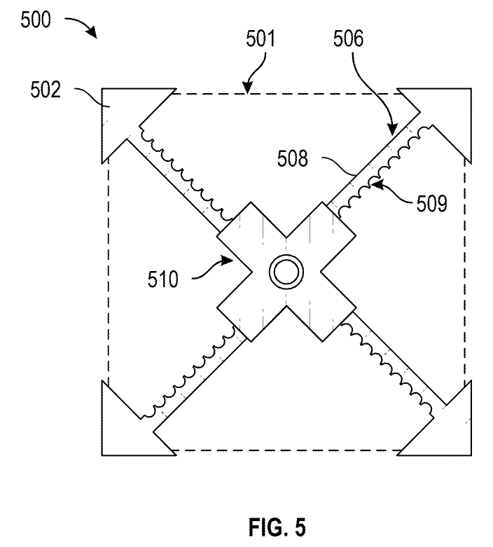

FIGS. 5 to 8 illustrate schematic views of an article security device 500 according to some aspects of the present disclosure. The security device 500 may share features with, and/or may be analogous with, the article security device 200 described with respect to FIGS. 2 and 3. For example, the security device 500 may provide corner capture while maintaining visibility of a front face of a packaged article, similar to the corner-engaging captive portions 202 of FIGS. 2 and 3.

As shown in FIG. 5, the article security device 500 is configured to secure to an article 501, which may share features with the article 300 of FIG. 3. The article security device 500 includes a plurality of clamps or captive portions 502 (the terms captive portion and clamp may be used interchangeably herein) adapted to secure corners of the article 501, where the clamps 502 may share features with the captive portions 202 of FIGS. 2 and 3. Each clamp 502 includes a an extendable/retractable portion 506. The clamp 502 may be configured to captively engage a corner and/or adjacent edges of the article 501. The extendable/retractable portion 506 may share features with the extendable/retractable portions 206 of FIGS. 2 and 3 and may translate relative to a hub to adjust reach of the corresponding clamp 502. The clamp 502 and the extendable/retractable portion 506 may be integral (e.g., a unibody structure) or the clamp 502 may be coupled to the extendable/retractable portion 506 (e.g., by mechanical fasteners, welding, or adhesives).

In one example implementation, the extendable/retractable portion 506 is configured as an elongated section having a flat surface 508 on one side and an undulating profile 509 on an opposite side. The flat surface 508 may provide a guided sliding interface. The undulating profile 509 may provide a rack-like engagement surface usable by a locking and/or driving mechanism. The undulating profile 509 may include corrugations, waves, teeth, serrations, ripples, ridges, or combinations thereof, to provide incremental positioning and/or to resist back-driving when loaded.

Still referring to FIG. 5, the article security device 500 includes a hub 510 having a plurality of extended portions (not specifically labeled), where the hub 510 may share features with the hub 210 of FIGS. 2 and 3. The count of the plurality of extended portions may complement the count of the plurality of clamps 502. The hub 510 may have a substantially hollow profile and the plurality of extended portions may define channels therewithin to facilitate passage and guided translation of the plurality of extendable/retractable portions 506.

The hub 510 may house at least one theft-detection element, such as an Electronic Article Surveillance (EAS) device, to provide a notification of unauthorized removal of the article 501 from a retail store or controlled space. Such theft-detection element may share features with the security feature 219 described with respect to FIG. 2.

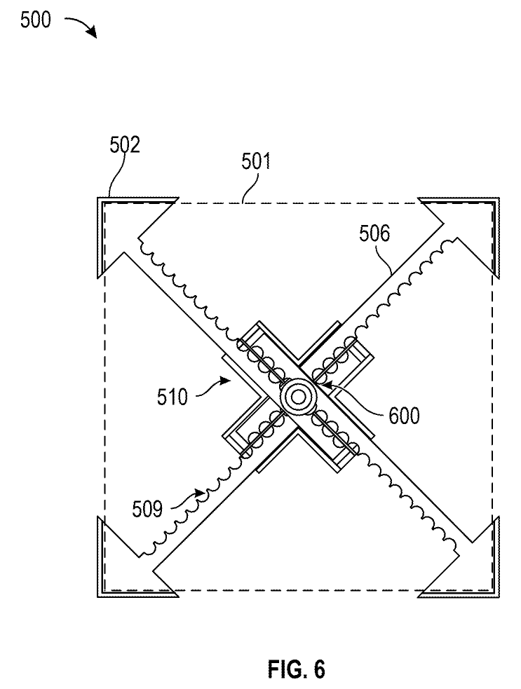

Now referring to FIGS. 6 along with 5, the hub 510 is shown to house a locking mechanism 600, where the locking mechanism 600 may share features with the tensioning/locking member 214 of FIG. 2. The locking mechanism 600 may facilitate movement of one or more extendable/retractable portions 506 into and out of the hub 510, thereby allowing the article security device 500 to expand around an article for engagement with corners or other surfaces thereof. The locking mechanism 600 may interact with the undulating profile 509 of an extendable/retractable portion 506. For example, the locking mechanism 600 may include a pinion or sprocket that engages the undulating profile 509 to drive the extendable/retractable portion 506, and may include a pawl, latch, brake, cam, wedge, or other lock element to hold the extendable/retractable portion 506 at a selected position. The extendable/retractable portion 506 may be configured to be locked at any one of several incrementally spaced positions relative to hub 510 based on tooth-to-tooth engagement with the undulating profile 509, or the extendable/retractable portion 506 may be configured to be locked at substantially any position (e.g., via frictional clamping or a continuously variable brake).

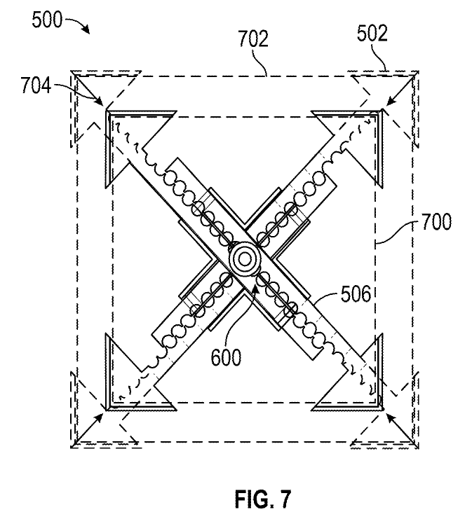

Referring to FIG. 7, the article security device 500 is shown in an example in which the device is adapted to align with respect to dimensions of an article 700 that is comparatively smaller than an article 702. In the example of FIG. 7, the locking mechanism 600 may facilitate simultaneous movement of the plurality of clamps 502 to accommodate different article sizes. To adapt the article security device 500 to the dimensions of the article 700, the plurality of clamps 502 may be displaced inward toward the hub 510 in a direction 704. Conversely, when the comparatively larger article 702 is to be secured by the article security device 500, the plurality of clamps 502 may be displaced in an opposite direction (e.g., outward from the hub 510) to increase overall reach. Accordingly, the article security device 500 may be adjusted based on the dimensions of the article being secured by displacing the plurality of clamps 502 and locking the extendable/retractable portions 506 relative to the hub 510.

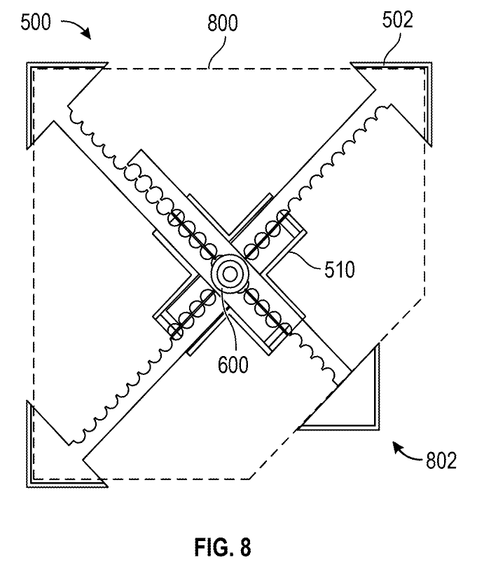

Referring to FIG. 8, the article security device 500 is shown securing an article 800 having a non-standard geometric profile. In the example of FIG. 8, the locking mechanism 600 may permit selective displacement of one clamp 502 relative to one or more other clamps 502 to better match the perimeter of the article 800. As shown, one clamp 502 is moved in an inward direction 802 to secure to a side and/or corner region of the article 800.

Now referring to FIG. 9, an article security device 900 is shown according to some aspects of the present disclosure. The article security device 900 may share features with, and/or may be analogous with, the article security device 200 described with respect to FIGS. 2-3 and/or the article security device 500 described with respect to FIGS. 5-8. The article security device 900 includes a plurality of clamps 902 configured to secure to one or more corners, edges, and/or peripheral regions of an article. The clamps 902 may share features with, or may be analogous with, the captive portions 202 of FIGS. 2-3 and/or the clamps 502 of FIGS. 5-8. For example, each clamp 902 may include a head configured to captively engage a corner (e.g., via a pocket, channel, hook-like feature, and/or compliant pad) and may be coupled to a movable member that is selectively repositionable relative to a hub to adjust reach.

The article security device 900 further includes a hub 904. The hub 904 may share features with, or may be analogous with, the hub 210 of FIGS. 2-3 and/or the hub 510 of FIGS. 5-8. For example, the hub 904 may provide a central housing that supports a locking mechanism and defines travel paths for movable portions of the clamps 902, similar to the extensions 212 of FIG. 2 and/or the extended portions and internal channels of FIG. 5. The hub 904 may be positioned against a rear surface of an article during use so that the corner-engaging clamps 902 secure the article while maintaining visibility of a front face.

A locking mechanism 905 may be housed within the hub 904. The locking mechanism 905 may share features with, or may be analogous with, the cable driver/tensioning and locking member 214 of FIGS. 2-3 and/or the locking mechanism 600 of FIGS. 5-8. For example, the locking mechanism 905 may be configured to regulate linear movement of one or more clamps 902 toward and away from the hub 904 (e.g., into and out of the hub 904) by locking a driven element against back-driving, using a ratchet-and-pawl, brake, cam, wedge, or magnetically releasable latch. In a further example, the locking mechanism 905 may be compatible with authorized unlocking via a detacher (e.g., a magnetic detacher) consistent with the locking arrangements described herein with respect to the cable driver 214.

In addition to regulating linear displacement, the locking mechanism 905 may facilitate angular displacement of one or more clamps 902 relative to the hub 904. For example, the hub 904 may include one or more pivots, tracks, arcuate slots, concentric plates, or layered rotary carriers that permit the clamps 902 (or respective extensions coupled thereto) to rotate about a central axis of the hub 904 while also permitting radial movement. In one example, the locking mechanism 905 selectively locks an angular position of each clamp 902 (e.g., via a detent, toothed ring, or friction brake) and separately locks a radial position (e.g., via a rack engagement similar to the undulating profile 509 of FIG. 5 or via cable tensioning similar to cables 208 of FIG. 2). In another example, the locking mechanism 905 locks both angular and radial positions by immobilizing a common driving member until authorized release.

As shown in FIG. 9, the article security device 900 may be used to secure articles of different aspect ratios. For example, an article 906 having a square-shaped profile may be secured with the clamps 902 arranged at generally symmetric angular positions and radial reaches relative to the hub 904. An article 908 having a rectangular-shaped profile may be secured by changing the angular positions and/or the radial positions of one or more clamps 902 so that the clamps 902 align with corners of the rectangular profile, while still maintaining retention against removal. Accordingly, the article security device 900 may be configured to provide linear and/or angular displacement of one or more clamps 902 to accommodate either of the articles 906, 908.

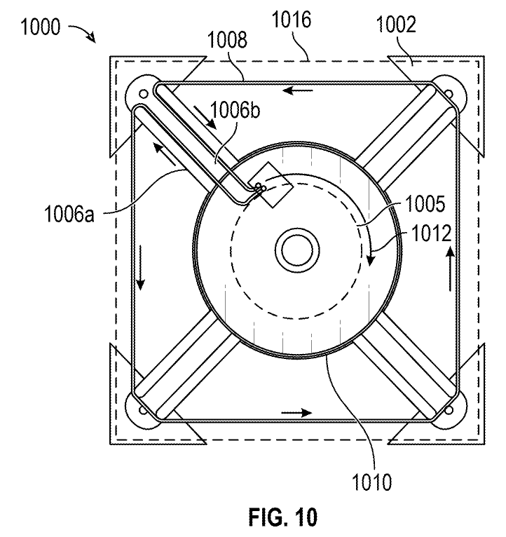

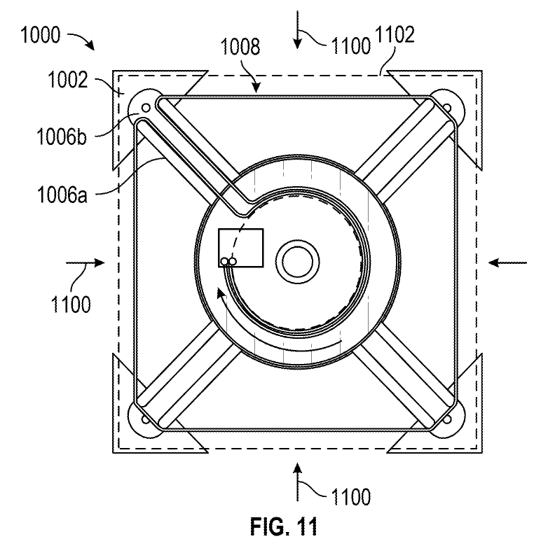

Now referring to FIGS. 10 and 11, schematic views of an article security device 1000 are shown according to some aspects of the present disclosure. The article security device 1000 may share features with, or may be analogous with, the article security device 200 described with respect to FIGS. 2-3, the article security device 500 described with respect to FIGS. 5-8, and/or the article security device 900 described with respect to FIG. 9. The article security device 1000 includes a hub 1010, one or more clamps or captive members 1002, at least one cable 1008, and a cable driver 1005. The hub 1010 may share features with, or may be analogous with, the hubs 210, 510, and/or 904, including a housing configured to conceal and protect an actuation and locking mechanism and to support one or more security features. The one or more captive members 1002 may share features with, or may be analogous with, the captive portions 202, clamps 502, and/or clamps 902, and may be configured to captively engage corners and/or edges of an article. The cable driver 1005 may share features with, or may be analogous with, the tensioning/locking member 214, the locking mechanism 600, and/or the locking mechanism 905, including a lockable winding mechanism releasable by an authorized detacher (e.g., a magnetic detacher) and configured to regulate winding and unwinding of the cable 1008.

In the illustrated example, the one or more clamps 1002 are configured to secure to corners of an article 1016. The article 1016 may share features with, or may be analogous with, the articles 300, 501, 700, 702, 800, 906, and/or 908, including retail packaging having corner regions captively engaged by corner clamps while leaving a front face substantially unobstructed. Each clamp 1002 (which may be interchangeably referred to as a captive portion) may share features with, or may be analogous with captive portions 202, and/or the heads, including corner-receiving pockets, edge-receiving channels, hook-like features, compliant pads, and/or other structures configured to captively engage a corner and resist removal. The extendable/retractable portion 1006a may share features with, or may be analogous with, the extendable/retractable portions 206 and/or the extendable/retractable portions 506, including an elongated member guided by the hub and repositionable to change an overall reach of the device.

The cable 1008 extends from the hub 1010 and is coupled to the one or more clamps 1002. The cable 1008 may share features with, or may be analogous with, the cables 208, including being routed along a surface of an article and being windable and unwindable by a driver housed in the hub. The cable 1008 may travel along a rear surface of the article 1016 so that a front surface of the article remains visible. The cable driver 1005 is configured to facilitate winding and unwinding of the cable 1008 to regulate displacement of the one or more clamps 1002 relative to the hub 1010. For example, the cable driver 1005 may rotate in a clockwise direction 1012 to wind the cable 1008, thereby reducing an effective cable loop size and drawing the clamps 1002 inward to reduce reach of the article security device 1000. The clockwise direction 1012 may correspond to a winding direction that increases cable tension in a manner similar to winding by the cable driver 214. Rotation may continue until the clamps 1002 captively engage respective corners of the article 1016 and the cable driver 1005 locks to maintain a selected tension.

FIG. 11 illustrates securement of an article 1102 that is smaller in at least one dimension than the article 1016 of FIG. 10. The article 1102 may share features with, or may be analogous with, the article 700 relative to the article 702, in that the device 1000 is adjustable to accommodate different article sizes. As shown, continued winding of the cable 1008 via the cable driver 1005 draws the clamps 1002 inward, represented by inward movement 1100, such that the clamps 1002 remain captively engaged while the device conforms to the smaller perimeter of the article 1102. The inward movement 1100 may correspond to inward displacement of corner clamps toward a hub similar to the inward displacement described with respect to direction 704 and/or direction 802.

In the illustrated example, the cable 1008 extends from the hub 1010 and terminates at the hub 1010, thereby forming a loop that cooperates with the clamps 1002. The extendable/retractable portion 1006a of at least one clamp 1002 includes a channel 1006b. The channel 1006b may serve as a fairlead and/or routing feature and may share features with, or may be analogous with, cable routing channels, guides, and protected passages described with respect to the extensions 212 and cables 208. In one example implementation, the cable 1008 exits the hub 1010 in one direction, passes through the channel 1006b of one clamp 1002, and further routes around and/or through the remaining clamps 1002, before returning to the hub 1010 via the same channel 1006b. As the cable driver 1005 winds the cable 1008, the cable loop tightens and draws the clamps 1002 inward collectively. Conversely, authorized unlocking and unwinding loosens the cable 1008, increases an effective loop size, and permits the clamps 1002 to move outward to facilitate removal.

The device 1000 may include one or more security features configured to detect tamper and/or cooperate with the retail security and/or tracking system described with respect to retail store facility 100 and gateway 102. For example, the cable 1008 may be electrically monitored (e.g., as a conductive continuity loop) such that cutting, severing, or abnormal stretching changes an electrical characteristic and causes the device 1000 to generate a local alarm and/or transmit an alert. In another example implementation, a tension sensor, spool rotation sensor, or encoder associated with the cable driver 1005 detects that the clamps 1002 have been pulled outward beyond a predetermined limit or that the cable has experienced a rapid tension drop indicative of cutting, and the device 1000 outputs an alarm. The device 1000 may additionally, or alternatively, include an EAS element, an RFID element, and/or a wireless transmitter to allow detection and correlation at gateway 102, consistent with the security feature 219 described herein.

Non-limiting variations of the device 1000 may be implemented without departing from the scope of the disclosure. For example, the device 1000 may use a single continuous cable loop as shown, or may use a plurality of cables (e.g., one cable per clamp) windable on one or more spools, similar to the plurality of cables 208 described with respect to the cable driver 214. The device 1000 may also use two cable loops, such as an upper loop around an upper half of the article and a lower loop around a lower half of the article, to improve stability on taller packages and to resist tilting of one or more clamps. The cable driver 1005 may provide collective adjustment (e.g., simultaneous movement of the clamps 1002), or may be configured to permit selective adjustment of one clamp relative to other clamps via a selector and independently lockable spools. The extendable/retractable portions 1006a may include telescoping sections to increase reach, similar to telescopic arrangements described for extendable/retractable portions 206 and/or for clamp structures described herein. The cable driver 1005 may include a ratchet-and-pawl lock, a brake, a wedge, and/or a cam lock, and may be magnetically releasable to support authorized detachment at point of sale, consistent with the locking approaches described for the cable driver 214 and locking mechanisms 600 and 905.

Aspects of the disclosure are further described in the clauses that follow:

Clause 1. An article security device, comprising: an article surveillance device; a hub; a first captive portion configured to engage with a first surface portion of an article, a second captive portion configured to engage with a second surface portion of the article; at least one moveable member coupled to the first captive portion and extending from the hub, wherein the at least one moveable member is configured to slide or telescope linearly with respect to the hub; and a locking member configured to releasably lock lateral movement of the at least one moveable member with respect to the hub.

Clause 2. The article security device of clause 1, wherein the at least one moveable member comprises at least one cable, wherein the cable constrains the lateral movement of the at least one moveable member with respect to the hub.

Clause 3. The article security device of any of the preceding clauses, further comprising at least one cable to the first captive portion or the moveable member, wherein the locking member is configured to selectively take up the at least one cable to regulate a position of the first captive portion relative to the hub.

Clause 4. The article security device of any of the preceding clauses, wherein the locking member comprises one or more spools configured to wind and unwind the at least one cable.

Clause 5. The article security device of clause 1, wherein the hub comprises a plurality of extensions, each extension defining a channel configured to constrain and provide a linear travel path for the at least one moveable member.

Clause 6. The article security of any of the preceding clauses, wherein the first captive portion includes a concave portion configured to engage with a corner of the article.

Clause 7. The article security of any of the preceding clauses, wherein the second captive portion is coupled to a second moveable member and extends from the hub, wherein the second moveable member is configured to slide or telescope linearly with respect to the hub.

Clause 8. The article security device of any of the preceding clauses, further comprising: a third captive portion coupled to a third moveable member that extends from the hub, wherein the third moveable member is configured to slide or telescope linearly with respect to the hub; and a fourth captive portion coupled to a fourth moveable member that extends from the hub, wherein the fourth moveable member is configured to slide to telescope linearly with respect to the hub.

Clause 9. The article security device of any of the preceding clauses, further comprising at least one cable member coupled to at least the first and second captive portions, wherein the cable member is coupled to the locking member.

Clause 10. The article security device of any of the preceding clauses, wherein the cable member is coupled to the third and fourth captive portions.

Clause 11. The article security device of any of the preceding clauses, wherein the first and second moveable members extend diagonally along a surface of the article when the article security device is coupled to the article.

Clause 12. The article security device of any of the preceding clauses, wherein the locking member is configured to independently regulate movement of at least two of the plurality of moveable members.

Clause 13. The article security device of any of the preceding clauses, further comprising a lock-release mechanism housed within the hub and configured to selectively immobilize and selectively release the locking member.

Clause 14. The article security device of any of the preceding clauses, wherein the at least one moveable member comprises an extendable/retractable portion having a toothed or ridged profile, and the locking member is configured to engage the toothed or ridged profile to regulate movement of the first captive portion.

Clause 15. The article security device of any of the preceding clauses, wherein the second captive portion is coupled to a second moveable member and extends from the hub, wherein the second moveable member is configured to slide or telescope linearly with respect to the hub, the article security device further comprising: a third captive portion coupled to a third moveable member that extends from the hub, wherein the third moveable member is configured to slide or telescope linearly with respect to the hub; and a fourth captive portion coupled to a fourth moveable member that extends from the hub, wherein the fourth moveable member is configured to slide to telescope linearly with respect to the hub, wherein the first moveable member, second moveable member, third moveable member and fourth moveable member each comprise an extendable/retractable portion having a toothed or ridged profile, and the locking member is configured to engage the toothed or ridged profile to regulate movement of the first captive portion, the second captive portion, the third captive portion and the fourth captive portion.

Clause 16. An article security device, comprising: an article surveillance device; a hub; a first captive portion configured to engage with a first surface portion of an article, a second captive portion configured to engage with a second surface portion of the article; at least one moveable member coupled to the first captive portion and extending from the hub, wherein the at least one moveable member is configured to slide or telescope linearly with respect to the hub; a cable coupled to the first captive portion; and a locking member at the hub configured to releasably lock lateral movement of the cable with respect to the hub.

Clause 17. The article security device of clause 16, wherein the second captive portion is coupled to a second moveable member and extends from the hub, wherein the second moveable member is configured to slide or telescope linearly with respect to the hub, the article security device further comprising: a third captive portion coupled to a third moveable member that extends from the hub, wherein the third moveable member is configured to slide or telescope linearly with respect to the hub; and a fourth captive portion coupled to a fourth moveable member that extends from the hub, wherein the fourth moveable member is configured to slide to telescope linearly with respect to the hub, wherein the first moveable member, second moveable member, third moveable member and fourth moveable member are each connected to the locking member via cables.

Clause 18. The article security device of any of the preceding clauses, wherein the second captive portion is coupled to a second moveable member and extends from the hub, wherein the second moveable member is configured to slide or telescope linearly with respect to the hub, the article security device further comprising: a third captive portion coupled to a third moveable member that extends from the hub, wherein the third moveable member is configured to slide or telescope linearly with respect to the hub; and a fourth captive portion coupled to a fourth moveable member that extends from the hub, wherein the fourth moveable member is configured to slide to telescope linearly with respect to the hub, wherein the first moveable member, second moveable member, third moveable member and fourth moveable member are each connected to the locking member via the cable.

Clause 19. An article security device, comprising: an article surveillance device; a hub; a locking member; a first captive portion configured to engage with a first surface portion of an article, a second captive portion configured to engage with a second surface portion of the article; at least one moveable member coupled to the first captive portion and extending from the hub, wherein the at least one moveable member is configured to slide or telescope linearly with respect to the hub, wherein the at least one moveable member comprises a portion having a toothed or ridged profile, and the locking member is configured to engage the toothed or ridged profile to regulate movement of the first captive portion.

Clause 20. The article security device of clause 19, wherein the locking member comprises a locking gear configured to engage with the toothed or ridged profile of the moveable member.

While the invention has been described with reference to one or more aspects of the disclosure, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment(s) disclosed as the best mode contemplated for carrying out this invention, but that the invention will include all aspects of the disclosure falling within the scope of the appended claims.

The construction and arrangement of the systems as shown in the various exemplary aspects of the disclosure are illustrative only. Although only a few aspects of the disclosure have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. Other substitutions, modifications, changes, and omissions can be made in the design, operating conditions, and arrangement of the exemplary aspects of the disclosure without departing from the scope of the present disclosure.

The present disclosure contemplates systems and program products on any machine-readable media for accomplishing various operations. The aspects of the disclosure of the present disclosure can be implemented using existing computer processors, or by a special purpose computer processor for an appropriate system, incorporated for this or another purpose, or by a hardwired system. Aspects of the disclosure within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. An article security device, comprising:
an article surveillance device;
a hub;
a first captive portion configured to engage with a first surface portion of an article,
a second captive portion configured to engage with a second surface portion of the article;
at least one moveable member coupled to the first captive portion and extending from the hub, wherein the at least one moveable member is configured to slide or telescope linearly with respect to the hub; and
a locking member configured to releasably lock lateral movement of the at least one moveable member with respect to the hub.

2. The article security device of claim 1, wherein the at least one moveable member comprises at least one cable, wherein the cable constrains the lateral movement of the at least one moveable member with respect to the hub.

3. The article security device of claim 1, further comprising at least one cable to the first captive portion or the moveable member, wherein the locking member is configured to selectively take up the at least one cable to regulate a position of the first captive portion relative to the hub.

4. The article security device of claim 3, wherein the locking member comprises one or more spools configured to wind and unwind the at least one cable.

5. The article security device of claim 1, wherein the hub comprises a plurality of extensions, each extension defining a channel configured to constrain and provide a linear travel path for the at least one moveable member.

6. The article security device of claim 1, wherein the first captive portion includes a concave portion configured to engage with a corner of the article.

7. The article security device of claim 1, wherein the second captive portion is coupled to a second moveable member and extends from the hub, wherein the second moveable member is configured to slide or telescope linearly with respect to the hub.

8. The article security device of claim 7, further comprising:
a third captive portion coupled to a third moveable member that extends from the hub, wherein the third moveable member is configured to slide or telescope linearly with respect to the hub; and
a fourth captive portion coupled to a fourth moveable member that extends from the hub, wherein the fourth moveable member is configured to slide to telescope linearly with respect to the hub.

9. The article security device of claim 8, further comprising at least one cable member coupled to at least the first and second captive portions, wherein the cable member is coupled to the locking member.

10. The article security device of claim 9, wherein the cable member is coupled to the third and fourth captive portions.

11. The article security device of claim 7, wherein the first and second moveable members extend diagonally along a surface of the article when the article security device is coupled to the article.

12. The article security device of claim 8, wherein the locking member is configured to independently regulate movement of at least two of the plurality of moveable members.

13. The article security device of claim 1, further comprising a lock-release mechanism housed within the hub and configured to selectively immobilize and selectively release the locking member.

14. The article security device of claim 1, wherein the at least one moveable member comprises an extendable/retractable portion having a toothed or ridged profile, and the locking member is configured to engage the toothed or ridged profile to regulate movement of the first captive portion.

15. The article security device of claim 1, wherein the second captive portion is coupled to a second moveable member and extends from the hub, wherein the second moveable member is configured to slide or telescope linearly with respect to the hub, the article security device further comprising:
a third captive portion coupled to a third moveable member that extends from the hub, wherein the third moveable member is configured to slide or telescope linearly with respect to the hub; and
a fourth captive portion coupled to a fourth moveable member that extends from the hub, wherein the fourth moveable member is configured to slide to telescope linearly with respect to the hub, wherein the first moveable member, second moveable member, third moveable member and fourth moveable member each comprise an extendable/retractable portion having a toothed or ridged profile, and the locking member is configured to engage the toothed or ridged profile to regulate movement of the first captive portion, the second captive portion, the third captive portion and the fourth captive portion.

16. An article security device, comprising:
an article surveillance device;
a hub;
a first captive portion configured to engage with a first surface portion of an article,
a second captive portion configured to engage with a second surface portion of the article;
at least one moveable member coupled to the first captive portion and extending from the hub, wherein the at least one moveable member is configured to slide or telescope linearly with respect to the hub;
a cable coupled to the first captive portion; and
a locking member at the hub configured to releasably lock lateral movement of the cable with respect to the hub.

17. The article security device of claim 16, wherein the second captive portion is coupled to a second moveable member and extends from the hub, wherein the second moveable member is configured to slide or telescope linearly with respect to the hub, the article security device further comprising:
a third captive portion coupled to a third moveable member that extends from the hub, wherein the third moveable member is configured to slide or telescope linearly with respect to the hub; and
a fourth captive portion coupled to a fourth moveable member that extends from the hub, wherein the fourth moveable member is configured to slide to telescope linearly with respect to the hub, wherein the first moveable member, second moveable member, third moveable member and fourth moveable member are each connected to the locking member via cables.

18. The article security device of claim 16, wherein the second captive portion is coupled to a second moveable member and extends from the hub, wherein the second moveable member is configured to slide or telescope linearly with respect to the hub, the article security device further comprising:
a third captive portion coupled to a third moveable member that extends from the hub, wherein the third moveable member is configured to slide or telescope linearly with respect to the hub; and
a fourth captive portion coupled to a fourth moveable member that extends from the hub, wherein the fourth moveable member is configured to slide to telescope linearly with respect to the hub, wherein the first moveable member, second moveable member, third moveable member and fourth moveable member are each connected to the locking member via the cable.

19. An article security device, comprising:
an article surveillance device;
a hub;
a locking member;
a first captive portion configured to engage with a first surface portion of an article,
a second captive portion configured to engage with a second surface portion of the article;
at least one moveable member coupled to the first captive portion and extending from the hub, wherein the at least one moveable member is configured to slide or telescope linearly with respect to the hub, wherein the at least one moveable member comprises a portion having a toothed or ridged profile, and the locking member is configured to engage the toothed or ridged profile to regulate movement of the first captive portion.

20. The article security device of claim 19, wherein the locking member comprises a locking gear configured to engage with the toothed or ridged profile of the moveable member.
